(19) United States
(12) Patent Application Publication
(10) Pub. No.: US 2007/0271458 A1
(43) Pub. Date: Nov. 22, 2007

(54) AUTHENTICATING A TAMPER-RESISTANT MODULE IN A BASE STATION ROUTER

(76) Inventors: Peter Bosch, New Providence, NJ (US); Mark Kraml, Flanders, NJ (US); Sape Mullender, North Plainfield, NJ (US); Paul Polakos, Marlboro, NJ (US); Louis Samuel, Swindon (GB)

Correspondence Address: WILLIAMS, MORGAN & AMERSON, 10333 RICHMOND, SUITE 1100, HOUSTON, TX, 77042, US

(21) Appl. No.: 11/419,626

(22) Filed: May 22, 2006

(51) Int. Cl. H04L 9/00

(52) U.S. Cl. 713/168

(57) ABSTRACT

The present invention provides a method involving a tamper-resistant module and an authentication server. The method includes receiving, at the tamper-resistant module, information encrypted using a first secret key stored in the authentication server. The method also includes authenticating the authentication server in response to decrypting the information using a second secret key stored in the tamper-resistant module.

### BACKGROUND OF THE INVENTION

1. Field of the Invention

This invention relates generally to communication systems, and, more particularly, to wireless communication systems.

2. Description of the Related Art

Conventional wireless communication systems include access nodes, such as Nodes-B, base stations, base station routers, access points, and access networks, which provide wireless connectivity to mobile units over an air interface. FIG. 1 conceptually illustrates one exemplary embodiment of a conventional wireless communication system 100 that may be used to provide wireless connectivity to a mobile unit 105. In the illustrated embodiment, a base station 110 provides wireless connectivity to the mobile unit 105 over an air interface 115. The base station 110 may be communicatively coupled to a public switched telephone network (PSTN) 117 and/or an Internet Protocol (IP) network 118 via a variety of elements, including a radio network controller (RNC) 120, an authentication center (AuC) 125, a mobile switching center (MSC) 130, a serving general packet radio service (GPRS) support node (SGSN) 135, a gateway GPRS support node (GGSN) 140, and the like.

The conventional wireless communication system 100 can be configured to support secure communications over the air interface 115. In the illustrated embodiment, a secret key is stored in the mobile unit 105 in the authentication center 125. For example, a mobile unit may include a subscriber identity module (SIM) card that stores the secret key. In one authentication procedure, the SIM card in the mobile unit 105 and a network are mutually authenticated using the secret key. For example, the SGSN 135 may implement methods for authenticating the network to the mobile unit 105 and authenticating the mobile unit 105 to the network. Once the mobile unit 105 and the network have been mutually authenticated, the mobile unit 105 and the authentication center 125 may use the secret key to form session keys, such as integrity keys (IK) and/or ciphering keys (CK), which the authentication center 125 may provide to the SGSN 135 and/or the radio network controller 120.

The session keys may be used to ensure the integrity of transmitted information and/or to encrypt transmitted information. For example, the radio network controller 120 and/or the mobile unit 105 may use the integrity keys to create message authentication codes (MACs) that may be embedded in signaling messages and used to ensure the integrity of these messages. For another example, the radio network controller 120 and/or the mobile unit 105 may use the ciphering keys to encrypt information transmitted over the air interface 115. However, the security of the wireless communication system 100 may be compromised if the secret key is discovered by an attacker because the session keys may be derived directly from the secret keys. Accordingly, the session keys are typically stored in a physically secure location, such as the authentication center 125, which is usually located in central offices behind lock and key and so these elements are typically considered physically secure.

The protocol stacks executing on the various network elements described above may also be organized so that all security-related functions execute on physically secure network elements. The base station 110 is usually deployed in the field and so is considered physically insecure. The radio network controller 120, the authentication center 125, the mobile switching center 130, the SGSN 135, and the GGSN 140 are usually located in central offices behind lock and key and so these elements are typically considered physically secure. For example, session key establishment may be performed at the SGSN 135 and integrity protection/ciphering may be performed at the radio network controller 120. The base station 110 is considered an insecure network element and thus only acts to pass through (encrypted) data and it is not capable of decoding the messages it transmits and receives. In general, communication between the mobile unit 105 in the central infrastructure (which includes radio network controller 120, the authentication center 125, the mobile switching center 130, the SGSN 135, and the GGSN 140) is authenticated and protected, while communication within the central infrastructure and between the central infrastructure and external networks (such as telephone networks and the Internet) is not mandated to be secure.

Some access nodes collapse portions of the functionality of base stations, radio network controllers, SGSNs, and GGSNs into a single network element, e.g., a base station router. Collapsing these functions into a single element allows for more efficient network design, reduction of latency in the signaling and/or user planes, and simplification of the wireless communication system that may enable convergence between different access technologies. However, base station routers are intended to be deployed in the field and may therefore be considered physically insecure locations. Furthermore, base station routers may not be connected to physically secure networks and instead may be connected by insecure backhaul networks such as a public Internet. Wireless communication systems that implement base station routers may therefore include significantly more points of vulnerability than wireless communication systems that implement the conventional base station architecture described above. For example, the wireless communication system may be vulnerable to attacks on the air interface, the physically-insecure base station router, and the backhaul Internet.

Disclosure of session keys may result in significant disruptions of wireless communication service to the users that are currently utilizing the leaked session keys. For example, if a ciphering key is disclosed, then adversaries would be able to decrypt all data that is sent over the wireless channel between the radio network controller and the mobile unit that utilizes the leaked ciphering key. If both the ciphering key and the integrity key were to leak, an adversary would be capable of forging control messages to the mobile unit that uses the leaked session keys and potentially disrupting communication between the radio access networks and the mobile unit.

The vulnerability of a base station router may also depend upon the deployment scenario. For example, base station routers may be designed for residential deployment (e.g., for deployment in homes or small offices) or infrastructure deployment (e.g., for deployment in micro-cellular environments and/or macro-cellular environments). Base station routers that are deployed for residential or small office use may be reverse engineered to determine user identities, as well as the session keys associated with the users. Base station routers that are deployed in micro-cellular or macro-cellular environments may be less vulnerable to reverse engineering, but an adversary versed in the design of infrastructure base station routers may still be able to obtain access to session keys associated with users. For example, adversaries may exploit vulnerabilities in the application software, vulnerabilities in the operating system software, or other software components. Adversaries may also physically tamper with the base station router to access session keys that may be stored in main memory or on the system data bus.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is involving a tamper-resistant module and an authentication server. The method includes receiving, at the tamper-resistant module, information encrypted using a secret key shared by the authentication server and the tamper-resistant module. The method also includes authenticating the authentication server to the tamper-resistant module in response to decrypting the information using a secret key stored in the tamper-resistant module.

In another embodiment of the present invention, a method is provided involving a tamper-resistant module and an authentication server. The method includes providing, to the tamper-resistant module, information encrypted using a first secret key stored in the authentication server. The method also includes receiving information encrypted using a second secret key stored in the tamper-resistant module and authenticating the tamper-resistant module in response to decrypting the information using the first secret key.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a conventional wireless communication system that may be used to provide wireless connectivity to a mobile unit;

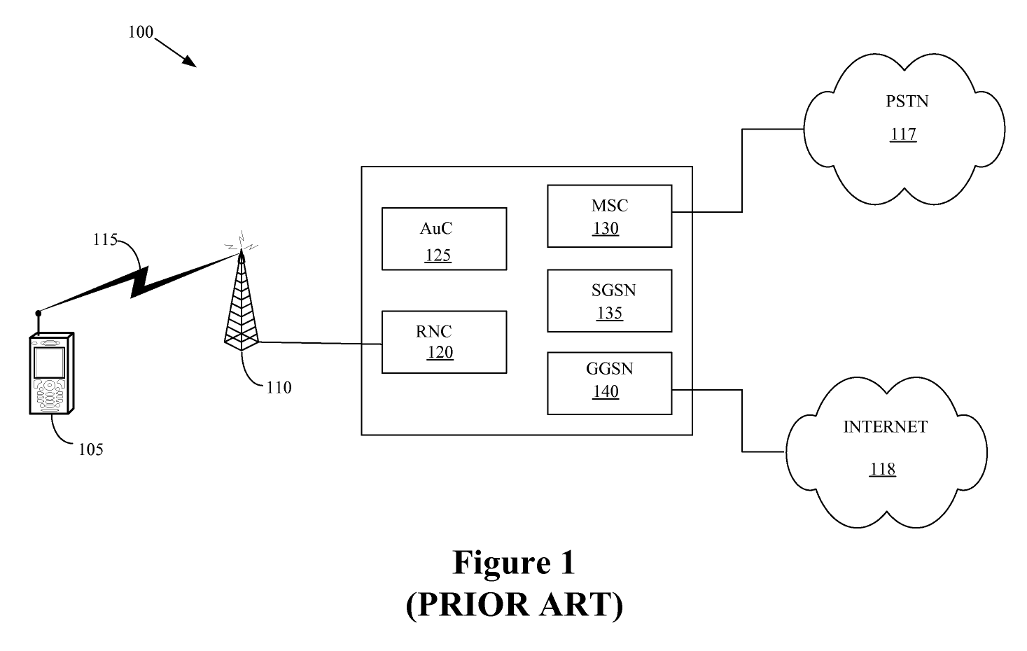

FIG. 2 conceptually illustrates one exemplary embodiment of a wireless communication system, in accordance with the present invention; and

FIG. 3 conceptually illustrates one exemplary embodiment of a method for authenticating a tamper-resistant module, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

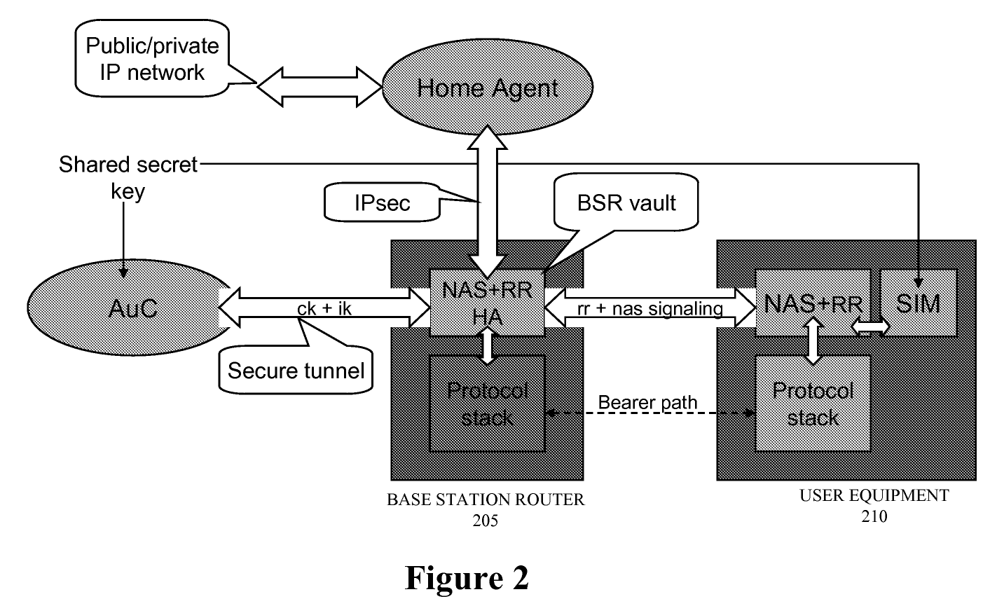

FIG. 2 conceptually illustrates one exemplary embodiment of a wireless communication system 200. In the illustrated embodiment, the wireless communication system includes at least one base station router 205 for providing wireless connectivity to one or more user equipment 210. Although a single base station router 205 and a single user equipment 210 are shown in FIG. 2, persons of ordinary skill in the art having benefit of the present disclosure should appreciate that the wireless communication system 200 may include any number of base station routers 205 and/or user equipment 210. Furthermore, in alternative embodiments, the wireless communication system 200 may include other types of access node besides the base station router 205. Exemplary user equipment 210 may include cellular telephones, personal data assistants, smart phones, text messaging devices, global positioning systems, navigation systems, pagers, network interface cards, notebook computers, desktop computers, and the like.

In the following discussion, the base station router 205 will be assumed to provide wireless connectivity to the user equipment 210 according to Universal Mobile Telecommunication System (UMTS) standards and/or protocols. However, persons of ordinary skill in the art having benefit of the present disclosure should appreciate that this assumption is not necessary for the practice of the present invention and in alternative embodiments other standards and/or protocols may be implemented in portions of the wireless communication system 200. For example, the base station router 205 may provide wireless connectivity to the user equipment 210 according to Global System for Mobile communication (GSM) standards and/or protocols.

The user equipment 210 includes a subscriber identity module (SIM), network non-access stratum (NAS) functionality, and radio resource (RR) functionality. The NAS functionality may be implemented as a functional layer running between the user equipment 210 and the base station router 205. The NAS layer supports traffic and signaling messages between the user equipment 210 and the base station router 205. The radio resource functionality is used to control resources for an air interface between the user equipment 210 and the base station router 205, or any other air interfaces available to the user equipment 210. The user equipment 210 also includes a protocol stack for supporting a radio bearer path between the user equipment 210 and the base station router 205. Techniques for implementing the SIM, NAS functionality, RR functionality, and/or the protocol stack are known to persons of ordinary skill in the art and in the interest of clarity only those aspects of implementing these layers that are relevant the present invention will be discussed further herein.

The base station router 205 includes a protocol stack that supports the radio bearer path between the base station router 205 and the user equipment 210. The base station router 205 also includes network non-access stratum (NAS) functionality, radio resource (RR) functionality, and foreign agent (FA) functionality. The home agent (HA) is the function within the wireless communication system 200 responsible for routing data to mobile nodes currently attached to a foreign network, e.g., the user equipment 210 if the user equipment 210 is currently roaming away from its home network. The HA forwards packets addressed to the user equipment 210 from the Public/private IP network to the FA; the FA then transfers it to the user equipment 210 via the protocol stack. The FA forwards packets addressed to nodes in the public/private IP network and generated by the user equipment 210 to the HA; the HA forwards them to their final destination. In the illustrated embodiment, the NAS functionality, the RR functionality, and the FA functionality are implemented within a base station router vault (BSR Vault).

The base station router vault is one example of a tamper-resistant module that may be implemented in access nodes such as the base station router 205. As used herein and in accordance with usage in the art, the term “tamper-resistant module” will be understood to refer to a module that implements a processing environment where one or more applications (e.g., the NAS functionality, the RR functionality, and the HA functionality) may execute isolated from software threads that may be executing outside of the tamper-resistant module. In one embodiment, the tamper-resistant module is implemented in hardware. For example, the tamper-resistant module may include a processing unit, a memory element, and other circuitry that are disengaged from a system bus such that the processing unit may execute applications stored in the memory element isolated from software threads executing outside of the tamper-resistant module. Applications executing in the tamper-resistant module may be stopped (and associated data erased or encrypted) if the module is opened or compromised in any way. An example of such hardware is the tamper-resistant IBM cell processor. In other embodiments, the tamper-resistant module may be implemented in software. For example, secure hyper-visor techniques may be used to limit the exposure of ciphering and/or integrity keys (and the associated algorithms) to adversaries by restricting such information to virtual processor domains. Furthermore, some embodiments may include tamper-resistant modules that are implemented in a combination of hardware, firmware, and/or software.

The wireless communication system 200 includes an authentication center or authentication server (AuC), which is used to authenticate elements of the wireless communication system 200. In one embodiment, the authentication center stores secret keys associated with the user equipment 210. For example, one copy of a secret key may be pre-provisioned to the authentication center and another copy of the secret key may be pre-provisioned to the SIM in the user equipment 210. The copies of the secret key may be used to authenticate communications between the wireless communication system 200 and the user equipment 210, as will be discussed in detail below.

The authentication center may also include a secret key that may be used to authenticate the base station router vault to the authentication center. For example, one copy of the secret key may be pre-provisioned to the authentication center and another copy of the secret key may be pre-provisioned to the base station router vault in the base station router 205. The copies of the secret key may be used to authenticate communications between the wireless communication system 200 and the base station router vault, as will be discussed in detail below. However, persons of ordinary skill in the art having benefit of the present disclosure should appreciate that the present invention is not limited to using pre-provisioned secret keys to mutually authenticate the base station router vault and the authentication center. In alternative embodiments, any authentication technique may be used to mutually authenticate the base station router vault and the authentication center.

Once the base station router vault has been authenticated to the wireless communication system 200, the authentication center may provide one or more session keys associated with the user equipment 210 (e.g., one or more ciphering keys CK and/or integrity keys IK) to the base station router vault via a secure tunnel between the authentication center and the base station router vault. In the illustrated embodiment, the base station router vault may perform authentication procedures associated with the user equipment 210 as will be discussed in detail below. Since the base station router vault is a tamper-resistant module, the base station router vault may be considered a secure location to store the session keys associated with the user equipment 210.

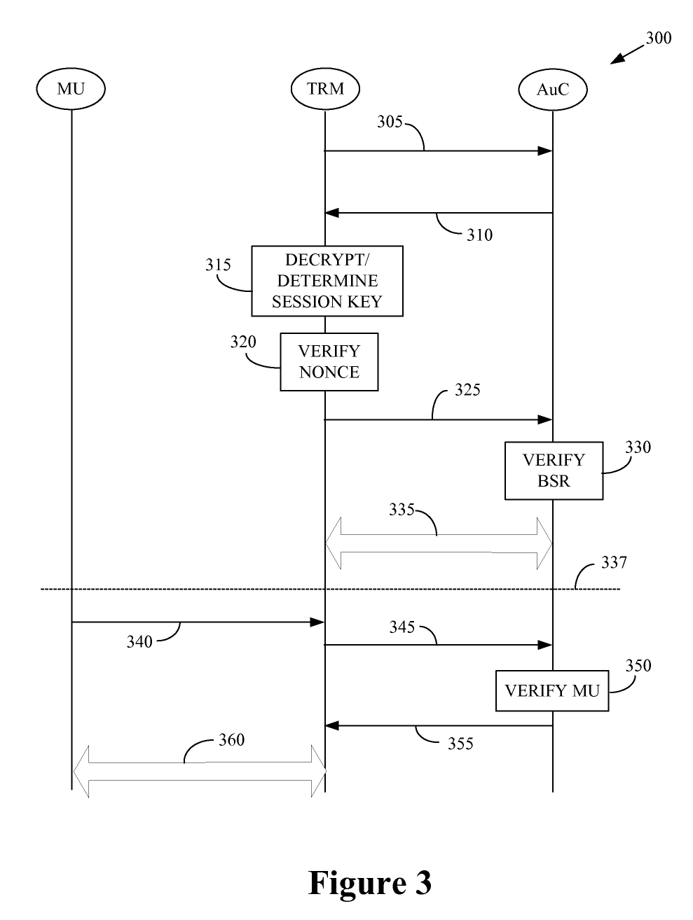

FIG. 3 conceptually illustrates one exemplary embodiment of a method 300 for authenticating a tamper-resistant module (TRM). In the illustrated embodiment, the tamper-resistant module includes a copy of a secret key. Another copy of the secret key is stored in the authentication center (AuC). The tamper-resistant module provides a message to the authentication center to initiate the authentication process, as indicated by the arrow 305. For example, the tamper-resistant module may send (at 305) a message including a nonce (e.g., a random number that is used later to verify freshness of the response message) and information indicating the identity of the base station router that includes the tamper-resistant module. In response to receiving the message (at 305), the authentication center forms a message using its copy of the secret key. In one embodiment, the message formed by the authentication center includes the nonce and one or more session keys that are encrypted using the copy of the secret key stored by the authentication center. This message is then provided to the tamper-resistant module, as indicated by the arrow 310.

The tamper-resistant module may then attempt to decrypt (at 315) the message 310 using the copy of the shared secret key stored by the tamper-resistant module. If the tamper-resistant module successfully decrypts (at 315) the message, then the tamper-resistant module may determine (at 315) one or more session keys that may be used for communications with the authentication center. Exemplary session keys may include ciphering keys that are used to encrypt and/or decrypt data transmitted between the tamper-resistant module and the authentication center. Exemplary session keys may also include integrity keys that may be used to protect the integrity of communication between the tamper-resistant module and the authentication center. The session keys may be formed from the shared secret key using techniques known to persons of ordinary skill in the art. In one embodiment, the tamper-resistant module may verify (at 320) that the nonce returned by the authentication center corresponds to the nonce provided at 305, thus verifying that the response 310 was formed in response to the request 305.

The tamper-resistant module provides a message that includes information encrypted using the provided session key(s) to the authentication center, as indicated by the arrow 325. The authentication center attempts to decrypt the message 325 using the session key and if the authentication center successfully decrypts the message 325, indicating that the tamper-resistant module has the copy of the shared secret key, the authentication center may verify (at 330) the tamper-resistant module. At this point, the tamper-resistant module and the authentication center may be considered mutually authenticated and may communicate using the secure tunnel 335. For example, information communicated between the tamper-resistant module and the authentication center through the secure tunnel 335 may be encrypted and/or decrypted using the session key(s). Subsequent communications between the tamper-resistant module and the authentication center (i.e., communications indicated below the dotted line 337) are assumed to be transmitted through the secure tunnel 335.

In the illustrated embodiment, the tamper-resistant module may be used to authenticate mobile units (MU) that establish communications with the base station router that includes the authenticated tamper-resistant module. For example, the mobile unit may provide a message requesting that secure communications be initiated with the base station router, as indicated by the arrows 340. The secure communication request message may be provided to the tamper-resistant module, which may then provide a message requesting session keys for communicating with the mobile unit to the authentication center, as indicated by the arrow 345.

The authentication center may verify (at 350) the identity of the mobile unit. For example, if the base station router is a residential-type base station router, the authentication center may verify (at 350) that the mobile unit is registered to the owner of the base station router. The authentication center may then provide (as indicated by the arrow 355) information indicative of one or more session keys associated with the mobile unit if the mobile unit has been successfully verified (at 350). For example, the authentication center may provide (at 355) an authentication vector including information indicative of a ciphering key and an integrity key associated with the mobile unit. The session keys may be formed using a secret key associated with the mobile unit that is pre-provisioned to the mobile unit and the authentication center.

The tamper-resistant module may use the session key(s) associated with the mobile unit to form a secure tunnel 360 between the mobile unit and the tamper-resistant module in the associated base station router. For example, ciphering keys associated with the mobile unit may be used to encrypt and/or decrypt information transmitted through the secure tunnel 360. For another example, integrity keys associated with the mobile unit may be used to ensure integrity of information transmitted through the secure tunnel 360. However, persons of ordinary skill in the art having benefit of the present disclosure should appreciate that any other techniques for establishing and/or maintaining the secure tunnel 360 may be used.

Referring back to FIG. 2, in some embodiments, the authentication center may elect to serve authentication requests from selected user equipment. For example, when an authentication request is received via a base station router that includes limited tamper-resistant hardware, such as a base station router that is deployed in a home, the authentication center can decide to serve authentication requests for authorized users associated with the base station router. An example of this is a home BSR deployment where only user equipment registered to the owner of the home BSR are allowed to place telephone/data calls. In this case, the authentication center only presents authentication vectors to the BSR for user equipment that are associated with the owner of the home BSR. In this scenario, the AuC does not provide the BSR with the authentication vectors of other users.

The BSR vault may also be used to implement functionality at a “functionally higher node.” For example, existing and/or proposed standards, such as the UMTS and/or the Systems-Architecture Evolution/Long-Term Evolution (SAE/LTE) standards and/or standard proposals make a distinction between (functionally lower) nodes that merely transfer authenticated and/or encrypted data from one network to another and (functionally higher) nodes that interpret and act on such data. In particular, nodes that act on data received and generate data to be sent are considered functionally higher nodes. Security and authentication functions may be run at the functionally higher nodes. In one embodiment, authentication, ciphering and integrity protection functionality for a UMTS system may therefore execute inside the BSR vault. When the BSR vault starts, it sets up a secure tunnel to the AuC and authenticates itself, as discussed above. However, instead of providing the established session key to external sources as described before, the BSR vault keeps such authentication vectors (and thus session keys CK and integrity keys IK) in a private memory store located within the BSR vault. Procedures that are used to mutually authenticate the user equipment and the network, such as UMTS (SAE/LTE) authentication procedures, may also be kept inside the BSR vault. Hence, in the UMTS example, NAS message processing may proceed in its entirety inside the BSR vault. Additionally, user-plane data encryption may include exchanging data between the BSR's main processor and the BSR vault. However, the ciphering and integrity keys are not to be exposed and/or maintained outside the BSR vault.

In some alternative embodiments, the base station router vault may be implemented using other techniques to limit the exposure of ciphering and integrity keys to adversaries. Secure hypervisor techniques, for example, can be used to limit the exposure of ciphering and integrity keys and their associated algorithms to adversaries by keeping such information in separate virtual processor domains. These techniques for implementing the base station router vault may provide adequate protection, especially when the secure hypervisor approach is combined with a tamper-resistant enclosure that prevents the system from operating as soon as the enclosure is opened.

The functionality for implementing mobility between base station routers and other base station routers or legacy devices may also be implemented in the base station router vault. For example, the BSR vault can maintain an encrypted container for relocating the session keys for nomadic users between base station routers and/or legacy devices. To relocate session keys from a legacy system, base station routers can use a secure tunnel to the legacy system if that exists (possibly through a signaling gateway). Alternatively, the base station router may decide to re-authenticate the user equipment if little trust can be placed in the security keys derived from the legacy system. The base station router may also decide to reuse the session keys from the legacy system regardless of integrity of the session keys.

In addition to providing the security functionality associated with maintaining a cellular system, some embodiments of base station routers also provide proxy functionality for communicating with a Mobile IP HA and possibly a session initiation protocol (SIP) server. In these embodiments, the session key that is transmitted by the authentication center to the base station router for a particular user can additionally be used for HA binding/registration and SIP authentication once the base station router has set up a secure communication path between itself and the authentication center. One embodiment of an HA binding/registration operation uses a keyed MD5 authentication algorithm to calculate a hash value over the registration request, but other algorithms can be applied as well. In one embodiment, the binding/registration update can be performed based on the session keys (e.g., the integrity key IK) that is made available to the base station router. Similarly, for SIP authentication, the integrity key IK or any other key derived from the shared secret key can be used to authenticate user equipment to an SIP server (not shown in FIG. 2). Both the HA and SIP server can validate the supplied credentials by contacting the authentication center.

Embodiments of the techniques described above can be used to protect the integrity and ciphering keys (IK and CK) inside a residential or infrastructural BSR. Depending on the techniques that are used, the security techniques described above may lead to a more secure environment when compared to existing (UMTS or SAE/LTE) approaches. Typically, a tradeoff may be made between the cost of securing a base station router and the potential increase in vulnerability that results from not making this investment. For example, a relatively low cost residential base station router may implement less stringent security mechanisms than an infrastructural base station router. A macro-cellular infrastructural BSR, on the other hand, can be equipped with sophisticated tamper-resistant hardware to prevent potential leakage of any of the secrets associated with the (potentially numerous) user equipment served by the base station router.

The security model described above allows wireless operators to decide which keys a base station router is allowed to manage based on the capabilities of the base station router. For example, when a residential BSR communicates with an authentication center, the authentication center can be instructed only to transmit only the security keys associated with a particular user to the base station router. Hence, by limiting the use of the residential base station router to the owner of the home BSR (or other authorized users), a security leak can only expose the secrets of a limited number of users. For another example, if an infrastructural BSR communicates with an authentication center, the authentication center can allow operations to continue much like it does with a current SGSN.

The security model described above is more flexible than existing solutions and avoids transmitting session keys between network elements other than the base station routers and the authentication centers. Since each base station router vault encapsulates the functionality associated with the security operations, there is no need to retransmit the security keys over a network to another network element as is the case in existing systems.

The techniques described above may also limit the damage caused by a successful attacker. Each base station router only provides service in a region that was typically served by a single Node B (e.g. a single carrier sector). This means that the number of users served by a base station router at any given time is much smaller than that served by an SGSN. For example, a base station router may store fewer keys that conventional network elements, such as the SGSN. Thus, in the unlikely event that a base station router is compromised, the attacker may only gain access to a few keys. In contrast, a SGSN (or, in the near future, the MME) serves a large number of users because each SGSN/MME provides services to many RNCs and Nodes B/eNBs. Thus, if a conventional SGSN is compromised, many more keys are potentially accessible, thus an adversary has a much greater impact. Thus, if an adversary executes a security attack to disrupt operations for a large number of users, the adversary needs to attack a much larger number of base station routers to reach the same effect attacking a single conventional SGSN.

In addition to securing the session keys CK and IK, the security architecture may provide a method to sign on to a macro-mobility anchor and to sign on to application services such as a SIP server. For example, the base station router may act as a proxy for both the mobility anchor registration and the SIP server registration. In both cases, the base station router can use the integrity key IK to authenticate the user to both services. Thus, if an adversary breaks in to a base station router to track a particular user, the base station router provides a better shielding mechanism for the user equipment since the attacker now needs to follow the mobile user equipment from base station router to base station router, rather than just breaking into a single SGSN.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method involving a tamper-resistant module and an authentication server, comprising:
receiving, at the tamper-resistant module, information encrypted using a first secret key stored in the authentication server; and
authenticating the authentication server in response to decrypting the information using a second secret key stored in the tamper-resistant module.

2. The method of claim 1, comprising attempting to decrypt the information using the second secret key stored in the tamper-resistant module.

3. The method of claim 1, comprising providing at least one of a first nonce and an identifier indicative of the tamper-resistant module to the authentication server.

4. The method of claim 3, wherein receiving the information encrypted using the first secret key comprises receiving the information in response to providing at least one of the first nonce and the identifier.

5. The method of claim 4, wherein receiving the information encrypted using the first secret key comprises receiving at least one second nonce encrypted using the first secret key, and wherein authenticating the authentication server comprises verifying that said at least one second nonce is the same as said at least one first nonce.

6. The method of claim 4, wherein receiving the information encrypted using the first secret key comprises receiving at least one first session key encrypted using the first secret key.

7. The method of claim 6, wherein receiving said at least one first session key comprises receiving at least one ciphering key and at least one integrity key associated with the tamper-resistant module and the authentication server.

8. The method of claim 6, comprising at least one of transmitting information to the authentication server using said at least one first session key and receiving information from the authentication server using said at least one first session key.

9. The method of claim 8, wherein receiving information from the authentication server comprises receiving at least one second session key associated with at least one mobile unit.

10. The method of claim 9, comprising receiving said at least one second session key comprises receiving said at least one second session key in response to transmitting information to the authentication server using said at least one first session key.

11. The method of claim 10, wherein receiving said at least one second session key associated with said at least one mobile unit comprises receiving at least one second session key formed using at least one third secret key stored in the authentication center.

12. The method of claim 10, comprising receiving, at the tamper-resistant module, encrypted information from at least one mobile unit, the information being encrypted based on at least one fourth secret key stored in the mobile unit, said at least one fourth secret key corresponding to said at least one third secret key stored in the authentication center.

13. The method of claim 12, comprising decrypting, based on said at least one second session key, the encrypted information received from said at least one mobile unit.

14. A method involving a tamper-resistant module and an authentication server, comprising:
providing, to the tamper-resistant module, information encrypted using a first secret key stored in the authentication server;
receiving information encrypted using a second secret key stored in the tamper-resistant module; and
authenticating the tamper-resistant module in response to decrypting the information using the first secret key.

15. The method of claim 14, comprising attempting to decrypt the information using the first secret key.

16. The method of claim 14, comprising receiving at least one of a first nonce and an identifier indicative of the tamper-resistant module.

17. The method of claim 16, wherein providing the information encrypted using the first secret key comprises providing the information in response to receiving at least one of the first nonce and the identifier.

18. The method of claim 17, wherein providing the information encrypted using the first secret key comprises providing at least one second nonce encrypted using the first secret key.

19. The method of claim 17, wherein providing the information encrypted using the first secret key comprises providing at least one first session key encrypted using the first secret key.

20. The method of claim 19, wherein providing said at least one first session key comprises providing at least one ciphering key and at least one integrity key associated with the tamper-resistant module and the authentication server.

21. The method of claim 19, comprising at least one of transmitting information to the tamper-resistant module using said at least one first session key and receiving information from the tamper-resistant module using said at least one first session key.

22. The method of claim 21, wherein providing information to the tamper-resistant module comprises providing at least one second session key associated with at least one mobile unit.

23. The method of claim 22, wherein providing said at least one second session key comprises providing said at least one second session key in response to receiving information from the tamper-resistant module formed using said at least one first session key.

24. The method of claim 23, wherein providing said at least one second session key associated with said at least one mobile unit comprises providing at least one second session key formed using at least one third secret key stored in the authentication center.
